(19) United States
(12) Patent Application Publication
(10) Pub. No.: US 2004/0048143 A1
(43) Pub. Date: Mar. 11, 2004

(54) Method, apparatus and computer program product for managing a rechargeable battery

(75) Inventor: Michael Joseph Stumpf, Austin, TX (US)

Correspondence Address: Mark E. McBurney, International Business Machines Corporation, Intr. Property Law Department, Internal Zip 4054, 11400 Burnet Road, Austin, TX, 78758, US

(73) Assignee: International Business Machines Corporation, Armonk, NY

(21) Appl. No.: 10/235,696

(22) Filed: Sep. 5, 2002

(51) Int. Cl. H01M 10/48

(52) U.S. Cl. 429/61; 429/62; 429/50

(57) ABSTRACT

In one form of the invention, a battery includes a rechargeable battery cell having replaceable sub-cells and sensors for measuring certain conditions of the sub-cells, including voltages, currents and temperatures. The battery also includes input and output switching devices coupled to the sub-cells. The switching devices are operable, responsive to respective first and second control signals, to selectively switch on a conductive path to a load and a conductive path to a source from selected ones of the sub-cells. Logic circuitry of the battery is coupled to the sensors and the input and output switching devices and is operable to automatically generate the control signals, responsive to the measured conditions, for switching a selected at least one of the sub-cells to supply the load and a selected at least one to recharge from the source.

### BACKGROUND OF THE INVENTION

1. Field of the Invention

The present invention relates to rechargeable batteries, and more particularly relates to improving the performance of rechargeable batteries, including Lithium Ion (“LiON”), Nickel Cadmium (“NiCd”), and Nickel Metal Anhydride (“NiMH”) based batteries.

2. Related Art

A battery coverts chemical energy within its material constituents into electrical energy in the process of discharging. A rechargeable battery is ideally returned to its original charged state (or substantially close to it) by passing an electrical current in the opposite direction to that of the discharge. Presently well-known rechargeable battery technologies include LiON, NiCd, and NiMH.

A battery typically includes one or more cells, which are often collectively described as a pack of cells or a set of cells. The set of cells are conductively coupled to form a power source. Each of the rechargeable cells provides a nominal fixed voltage, e.g., 1.2V for NiCd, and NiMH cells. Depending on the load requirements, individual cells included in the set maybe arranged in series to generate a higher voltage, or in some cases the cells may be arranged in parallel to provide a higher current. Use of rechargeable battery cells to power portable electronic devices such as cellular phones, laptop computers and personal digital assistants is well known.

A “memory effect” is a well known limitation of rechargeable battery cells, especially NiCd and NiMH cells. According to this effect, a cell retains the characteristic of a previous charge/discharge cycle. To avoid the memory effect, it is a common practice to fully discharge a battery before recharging it. However, for many applications it may be impractical to take a battery out of service for recharging or even to fully discharge the battery before recharging. Therefore, a need exists to improve the organization of battery cells to permit selectively discharging or recharging. In particular, it would be desirable to reduce the impact of memory effect on the operation of rechargeable battery cells and thereby improve cell life.

### SUMMARY

The foregoing need is addressed by the present invention. According to one form of the invention, a battery includes a first rechargeable battery cell having a number of replaceable sub-cells. The battery also includes sensors for measuring certain conditions of the sub-cells, including voltages, currents and temperatures, and an output switching device coupled to the sub-cells. The output switching device is operable, responsive to a first control signal, to selectively switch on a conductive path to a load from selected ones of the sub-cells. The battery also includes an input switching device coupled to the sub-cells. The input switching device is operable, responsive to a second control signal, to selectively switch on a conductive path to a source from selected ones of the sub-cells. Logic circuitry of the battery is coupled to the sensors and the input and output switching devices and is operable to automatically generate the control signals, responsive to the measured conditions, for switching a selected at least one of the sub-cells to supply the load and a selected at least one to recharge from the source.

Advantages and objectives of the invention, as well as other aspects and forms of the invention will become apparent upon reading the following detailed description and upon reference to the accompanying drawings.

### BRIEF DESCRIPTION OF THE DRAWINGS

FIG. 1 illustrates a block diagram of a battery, according to an embodiment of the invention.

FIG. 2 illustrates aspects of cell organization for the battery of FIG. 1, according to an embodiment of the invention.

FIG. 3 illustrates details of one of the discrete cells of FIG. 2, according to an embodiment of the invention.

FIG. 4 illustrates details for one of the functional cells of FIGS. 1 and 2, according to an embodiment.

FIG. 5 illustrates details for the control block of FIG. 1, according to an embodiment of the invention.

FIG. 6 illustrates an embodiment of a battery with only a single functional cell, according to an embodiment of the invention.

FIG. 7 illustrates a flow chart for aspects of the functioning of a rechargeable-cell, smart battery, according to an embodiment of the invention.

### DETAILED DESCRIPTION OF THE PREFERRED EMBODIMENT

In the following detailed description of the preferred embodiments, reference is made to the accompanying drawings illustrating embodiments in which the invention may be practiced. It should be understood, however, that the drawings and detailed description are not intended to limit the invention to the particular form disclosed, but on the contrary, the intention is to cover all modifications, equivalents and alternatives falling within the spirit and scope of the present invention as defined by the appended claims.

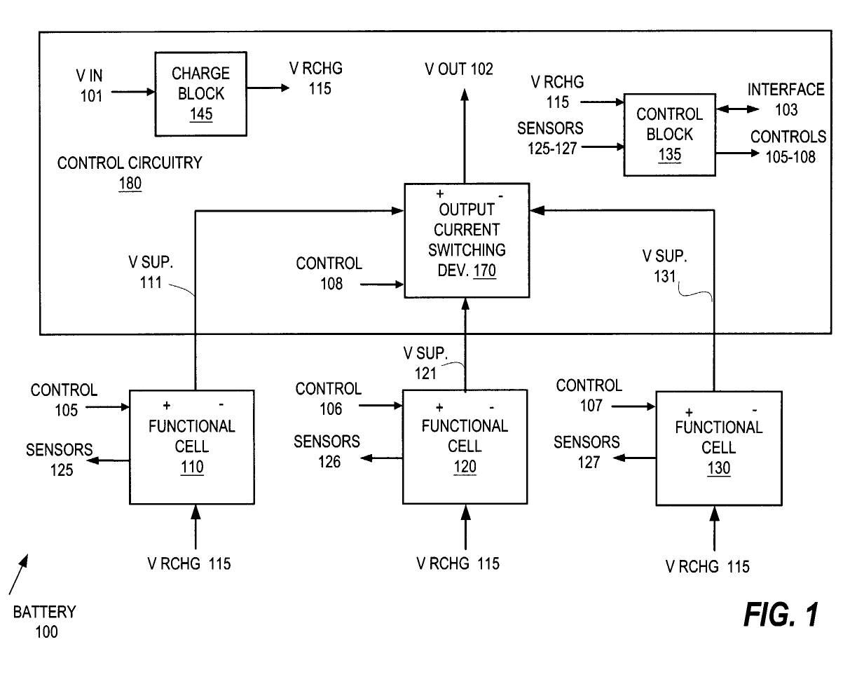

FIG. 1 illustrates a block diagram of a battery 100, according to an embodiment of the invention. The battery 100 has three rechargeable cells 110, 120 and 130, referred to herein as “functional cells.” (In other embodiments, the battery 100 has more or less than three functional cells.) In one embodiment, each cell 110, etc. has the capacity to provide rated power to a load (not shown). In another embodiment, each cell 110, etc. only has capacity to provide a portion of the rated power to the load, in which case a set of the cells, e.g, two of the cells, such as cells 110 and 120, are required to provide rated power to the load.

Battery 100 has control circuitry 180, which includes a control block 135, charge block 145 and output current switching device 170 interconnected as shown. Charge block 145 receives a voltage input 101 from an external source (not shown) and generates a recharge voltage 115 from the input 101. For example, charge block 145 may be supplied by an AC source which charge block 135 converts to a DC output voltage, recharge voltage 115. Recharge voltage 115 is coupled to the functional cells 110, etc. for charging or recharging the cells. That is, in a charge mode of operation the charge 115 signal is applied to a selected cell 110, 120 or 130, as will be described further herein below.

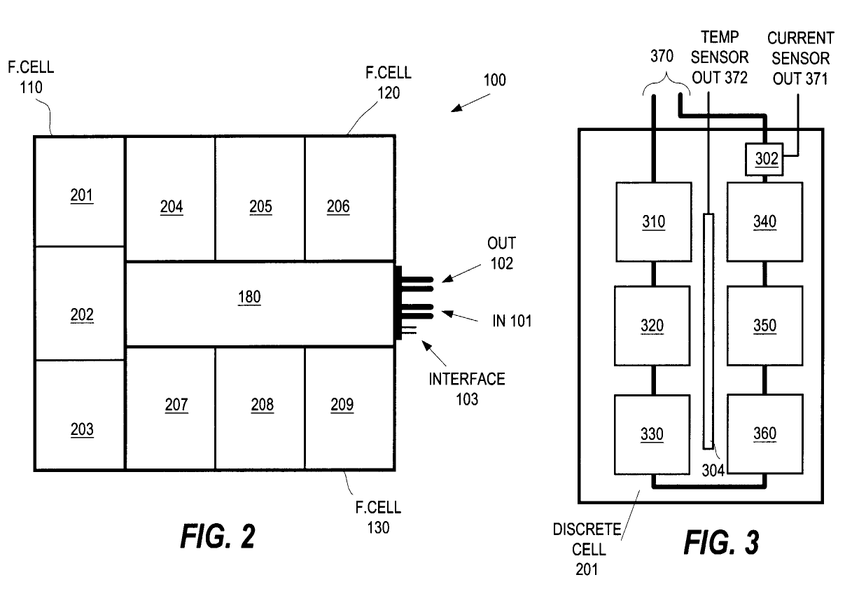

FIG. 2 shows additional aspects of cell organization for the battery 100 of FIG. 1, according to an embodiment of the invention. The battery 100 has 3 functional cells 110, 120 and 130 and control electronics 180. The three functional cells 110, 120 and 130 in this embodiment each have three sub-cells, referred to also as “discrete” cells. That is, functional cell 110 includes discrete cells 201-203, functional cell 120 includes discrete cells 204-206, and functional cell 130 includes discrete cells 207-209. (In other embodiments, the cells 110, etc. have more or less than three discrete cells.) For the previously mentioned voltage in 101 and voltage out 102, respective pairs of terminals are provided as shown to connect a power supply and to connect rated power to the load.

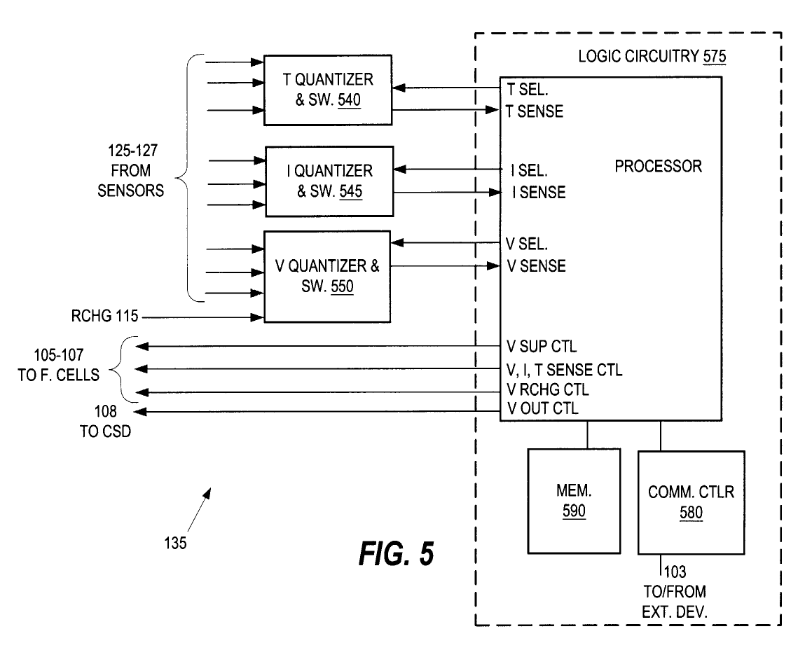

For interface 103, the control electronics 180 provides interface pins as shown to communicate with an external device (not shown), such as a cellular phone, laptop computer or personal digital assistant. The control electronics 180 may support well known communication standards such as Universal Serial Bus (“USB”) and SM Bus. A block diagram herein, FIG. 5, illustrates further details of control electronics 180, according to one embodiment.

FIG. 3 illustrates more details of the discrete cell 201 of FIG. 2, according to an embodiment of the invention. The details shown for cell 201 are typical for all the discrete cells 201-209 shown in FIG. 2. Sub-cell 201, i.e., discrete cell 201, includes a set of six rechargeable sub-sub-cells 310-360 connected in series, so that for this arrangement, with a nominal 1.2V potential for each sub-sub-cell 310-360, the voltage of the overall discrete cell 201 is 6V. In other embodiments the sub-sub-cells are connected in parallel or in a series-parallel combination according to the needed voltage or current capacity of the cell 201.

As shown, discrete cell 201 has sensors 302 and 304 for sensing current and battery temperature of the cell 201 and generating sensor signals 371 and 372. The measurements for the discrete cell 201 properties such as voltage, current and temperature maybe collected at time intervals defined by predetermined parameters. Signals 371 and 372 and voltage 370 at the terminals of the cell 201 are sent along with other similar signals for discrete cells 202 and 203 (FIG. 2) to control block 135 (FIG. 1). In FIG. 1 the set of all these signals is shown as “sensors” 125.

The discrete cells such as discrete cell 201 are the smallest modular unit for which sensor measurement is available and are the smallest replaceable units for maintenance or servicing A failure in any of sub-sub-cell 310, etc. affects the availability of its entire discrete cell 201. In the illustrated embodiment, a single temperature sensor 372 is shared among six rechargeable sub-sub-cells 310-360 rather than having a dedicated temperature sensor for each sub-sub-cell because this is generally more economical. It should be understood, however, that in other embodiments additional sensors are included.

Referring again to FIG. 1, sensors as shown in FIG. 3 are associated with the respective functional cells 110, etc. and their respective discrete cells (FIG. 2). These sensors generate sensor signals 125, 126 and 127 indicating battery temperatures of the respective discrete cells of the functional cells 110, 120 and 130 and current at the respective terminals of the discrete cells. Likewise, the voltages of the discrete cells are also sent to the control block 135 among signals 125, 126 and 127. Control block 135 also receives the charge 115 signal from charge block 145 and sends and receives interface signals 103 to an external device (not shown).

Note that herein, as is common in the art, the use of terms such as “signal” or “input” or “output” does not always explicitly distinguish between structure and function. One of ordinary skill in the art will understand from context that the terminology may indicate either structure or function or both. That is, for example, the term “signal” may refer in a general sense to the function of conveying logical information, or to a voltage, current, etc. that is generated to convey the information, or to a structure, such as a terminal or conductor for transmitting such a voltage or current.

Control block 135 has logic circuitry (not shown in FIG. 1) that determines operating status of each of the cells 110, 120 and 130 and their sub-cells responsive to the received signals 103, 115 and 125-127 and responsive to predetermined parameters to which the measured operating conditions are compared. Based on the status, the control block 135 logic circuitry generates and sends control signals 105-108 to the functional cells 110, etc. and the output current switching device (“CSD”) 170 for controlling operation of the battery 100. This includes selecting which of the cells 110, etc. and discrete cells 201, etc. supply voltage out 102 to an external load (not shown). That is, a cell such as cell 110 is selected to supply voltage out 102 by turning on a conductive path in the CSD 170 between the cell 110 and the load responsive to the control signal 108.

The output current switching device 170 includes interconnections (not shown) for the functional cells. As previously mentioned, in one embodiment current must be combined from more than one cell 110, 120 or 130 to provide rated power to the load. In such a case, the control 108 signal causes the CSD 170 to select more than one of the cells 110, 120 and 130 to provide power. In one embodiment, the CSD 170 switches all the cells 110, etc. in parallel to the load, and the functional cells 110, 120 and 130 thus operate to provide rated power for three times as long as would a single one of the cells 110, etc.

In one aspect of an embodiment, the cells 110, etc. and their sub-cells 201, etc. are initialized. During initialization, and later during recharging, cells and sub-cells are fully charged prior to changing operational status to “on-line.” The control block 135 logic circuitry determines whether the charge cycle for a cell or sub-cell is complete so that the cell or sub-cell is eligible to be placed on-line based on whether the sensor signals 125, 126 and 127 indicate a cell or sub-cell's voltage, current and temperature measurements have achieved an acceptable, predetermined range within a certain charging time interval, according to the predetermined parameters.

Once a sufficient number of the cells and sub-cells are initialized or recharged, the control block 135 logic circuitry may selectively place one or more of the cells and one or more of the sub-cells therein in-service to provide rated power to the load. Once placed in service, the selected cell(s) and sub-cell(s) provide power until a predefined event occurs, as defined by the predetermined parameters. One such predefined event is when a cell or subcell's voltage drops below a specified threshold value. Another is when a specified maximum allowable on-line time period expires for the cell or sub-cell. On detection of such an event, the cell or sub-cell is switched out of service, and another one of the cells is switched in service to supply the load. Preferably this is done without interrupting current output to the load. The cell or sub-cell that was switched out of service may be placed in a “charge” mode for recharging, or may be placed in “maintenance” mode for being replaced, according to which the cell or sub-cell is isolated from the load and the recharging source. At the same time one or more other cell or sub-cell of the battery 100 continue to provide rated power to the load.

The control block 135 logic uses various techniques to determine the health or the operational status of the cells based on comparing the predetermined parameters to the information included in the signals 125, 126 and 127 representing cell voltage, current and temperature. Details will be described further herein below. In summary, however, the techniques include the following. In one aspect, the logic circuitry of control block 135 determines fitness for operation of a selected cell by measuring a difference between voltages of a cell before and after charging the cell for a specified charging interval. If the difference in voltage exceeds a certain predetermined threshold then the selected battery cell needs to be placed out-of-service, i.e., isolated from the load. According to another aspect, the logic circuitry determines completion of the recharge cycle based on measuring a difference between temperatures of a cell before and after charging the cell for a specified charging interval. If the difference exceeds a certain predetermined threshold then the selected battery cell needs to be placed out-of-service.

Also, the control block 135 logic circuitry is operable to detect failures and correct a memory effect, which tends to avoid cell reversals and increase cell life. Logic circuitry of the battery determines that a memory effect is present in one of the cells responsive to the cell or sub-cell repeatedly recharging to less than a full charge. To correct the memory effect the control circuitry gives priority to selecting the cell or sub-cell to supply the load and deplete its charge. This includes possibly even repeatedly preferentially selecting the cell or sub-cell each time after it recharges rather than switching other ones of the cells or sub-cells into service. Failure detection includes detecting a false recharge, insufficient discharge, sub-cell reversal or repeated memory effect. In detecting false recharge, the measured values indicate a cell or sub-cell charges to a predetermined voltage level during charging but then discharges too quickly once placed in service. In detecting insufficient discharge, the measured values indicate a cell or sub-cell does not discharge to a sufficiently low voltage during service. In detecting sub-cell reversal, the measured values indicate at least one of the sub-subcells 310, etc. (FIG. 3) reverses polarity, such as by indicating a sudden drop in the voltage level of the sub cell. It should be appreciated that an important feature of the present invention is the capabilityto measure operating conditions over time, accumulate this data, compute rates and compare the data or computations to predetermined or externally supplied criteria.

In another aspect, the control block 135 logic circuitry is operable to compute a trickle charge, that is, to regulate and measure a current to a cell or sub-cell for a predetermined time interval within a predetermined voltage range.

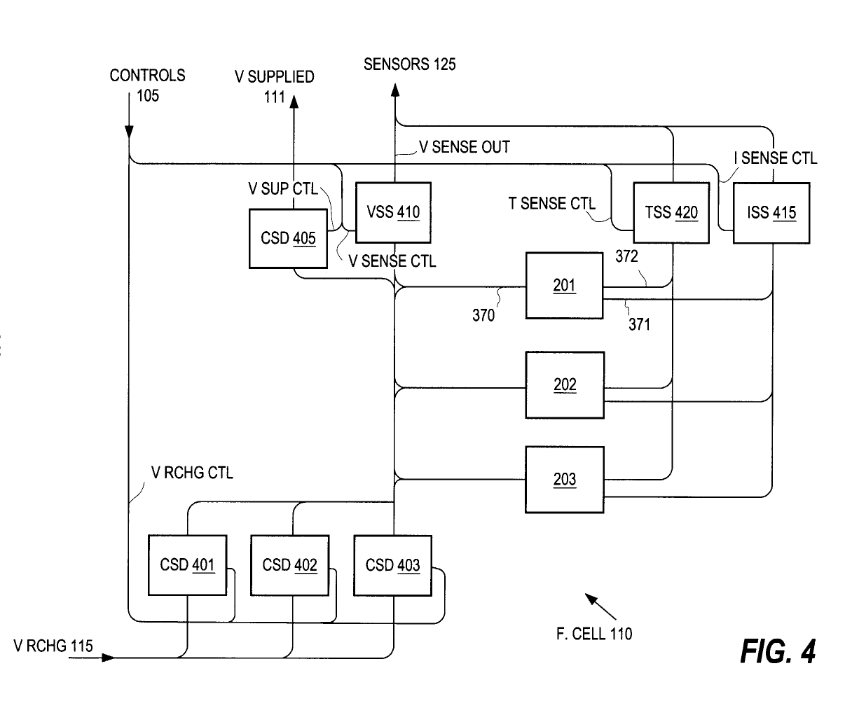

Referring now to FIG. 4, more details are illustrated for the functional cell 110 of FIGS. 1 and 2, according to an embodiment. (It should be understood that functional cell 110 is typical of all three functional cells 110, 120 and 130.) Functional cell 110 includes discrete cells 201, 202 and 203, as previously shown in FIG. 2. Functional cell 110 also includes a voltage selector switch (“VSS”) 410, a current selector switch (ISS“) 415, a temperature selector switch (“TSS”) 420 which receive control signals 105 from and send sensor signals 125 to control electronics 180 (FIG. 1). The cell 110 also includes input cell current switching devices (“CSD's”) 401, 402, 403, and output CSD 405. (Note that a number of CSD's such as input CSD's 401-403 may be a single “device.”) Output terminals of the discrete cells 201, 202 and 203 are all coupled to the VSS 410 and the CSD 405. (In FIG. 4, the output 370 is explicitly labeled for cell 201.) The output CSD 405 receives a V SUP CTL signal from among signals 105. The V SUP signal selects which ones of the cells 201, 202 and 203 supply the output voltage 102 from the functional cell 110 to control electronics 180 (FIG. 1).

The VSS 410 provides a mechanism to reduce the number of voltage inputs to the control electronics 180 (FIG. 1). More importantly, VSS 180 is operable to isolate the cells 201-203 so that the voltage of a cell 201, 202 or 203 can be measured independently of other voltages. VSS 410 is controlled by one of the control signals 105, V SENSE CTL, which selects a voltage from one of the cells 201, etc. to be asserted as V SENSE OUT, one of the sensor signals 125.

Also, the terminals of each of the discrete cells 201, 202 and 203 are coupled to respective ones of the input CSD's 401-403 which are in turn. The CSD's 401-403 are all coupled to the recharge voltage supply 115 from charge block 145 (FIG. 1). The control signals 105 include V RCHG CTL signals coupled to the respective CSD's 401-403 to turn on a selected one of the CSD's 401-403 for conducting the recharge voltage 115 to recharge the selected cell 201, 202 or 203.

The ISS 415 provides a mechanism to reduce the number of current inputs to the control electronics 180 (FIG. 1). ISS 410 is controlled by one of the control signals 105, I SENSE CTL, which selects a current from one of the cells 201, etc. to be asserted as I SENSE OUT, another one of the sensor signals 125. Likewise, the TSS 420 provides a mechanism to reduce the number of temperature inputs to the control electronics 180 (FIG. 1). TSS 420 is controlled by one of the control signals 105, T SENSE CTL, which selects a current from one of the cells 201, etc. to be asserted as T SENSE OUT, another one of the sensor signals 125.

Referring now to FIG. 5, more details are illustrated for control block 135 of FIG. 1, according to an embodiment of the invention. In the illustrated embodiment, the control block 135 includes logic circuitry 575 and temperature, current and voltage quantizer/switch devices 540, 545 and 550. Analog sensor signals 125-127 output from the functional cells 110-130 (FIG. 1) and the recharge voltage signal 115 from charge block 145 (FIG. 1) are received by the respective devices 540, 545 and 550. The signals 125-127 are selected responsive to T SEL, I SEL and V SEL from the logic circuitry 575, and the selected signals are converted by the devices 540, etc. to digital signals T SENSE, I SENSE, and V SENSE, which are output to the logic circuitry 575.

In the embodiment, the logic circuitry 575 includes a processor 510 operable to execute program instructions in response to the sensor signals 125, 126 and 127. The logic circuitry 575 also includes a communications controller 580 coupled to the processor 510 operable to communicate with the processor 510 and to communicate via interface 103 to external devices (not shown) using a standard protocol such as Ethernet, I2C, etc. This interface 103 is useful for receiving new program instructions and data specifying new operating parameters. The logic circuitry 575 also includes a persistent memory 590 coupled to the processor 510. The persistent memory 590 is used to store instructions (also known as a “software program”), predefined parameters specifying operating objectives, identifiers for the cells and sub-cells and measurements from the sensor signals providing a historical record of actual operating conditions. In one embodiment the historical record includes measured values for cell and sub-cell voltages versus time for several charge and discharge cycles, cell temperatures versus time for a predefined time interval, and voltages and corresponding timestamp values for a discharge low point and recharge high point. The record and identifiers may be transferred to an external device via the interface 103. In various embodiments the one or more software programs are implemented in various ways, including procedure-based techniques, component-based techniques, and/or object-oriented techniques, among others. Specific examples include XML, C, C++, Java and Microsoft Foundation Classes (MFC).

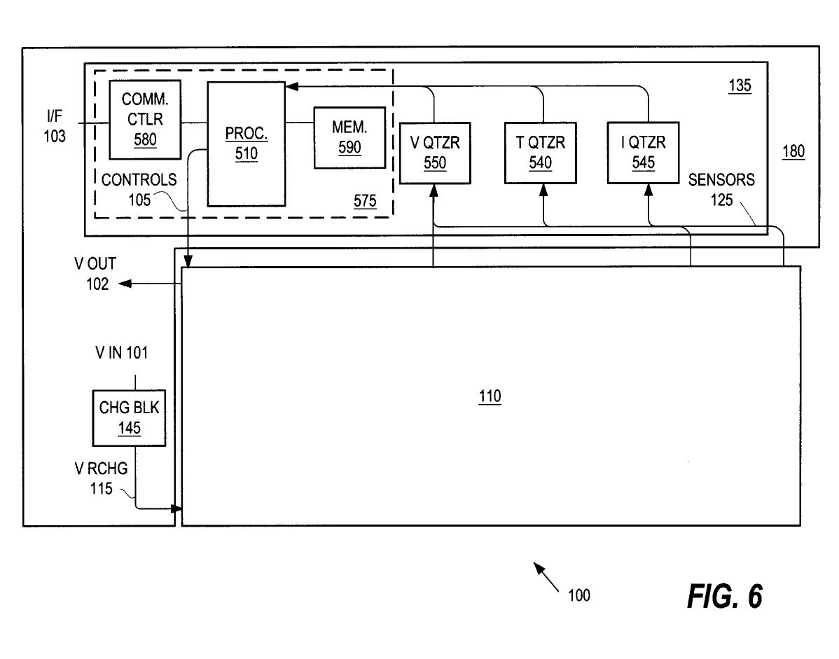

Referring now to FIG. 6, a simpler embodiment of the battery 100 is illustrated which has only a single functional cell 110. The functional cell 110 that is illustrated in FIG. 6 is identical to the functional cells 110 illustrated in FIG. 4. However, the control circuitry 180 is somewhat simpler than its counterpart illustrated in FIGS. 1 and 5. Specifically, since there is only one functional cell 110 in this embodiment, there is no need for the CSD 170 of FIG. 1 to select functional cells for supplying the output voltage 102. Instead, CSD 405 selects which ones of the sub-cells, i.e., discrete cells 201, 202 or 203, supply the output voltage 102. Likewise, there is no need for the quantizing devices 540, 545, and 550 to select among functional cells sensors. So in this embodiment the quantizing devices do not perform a selecting function and accordingly do not receive control signals for selecting.

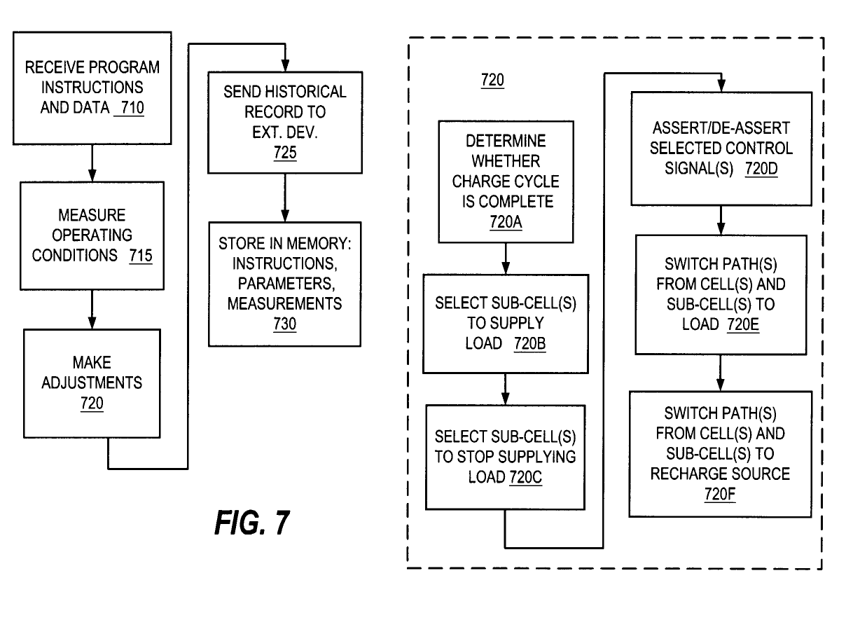

Referring to FIG. 7, a flow chart for aspects of the functioning of rechargeable-cell, smart battery 100 is shown, according to an embodiment of the invention. It should be understood that the events described herein are not limited so as to be necessarily performed in the sequence in which they are set out. The logic circuitry includes a processor operable to execute program instructions in response to the sensor signals and a memory coupled to the processor. The logic circuitry also includes a communications controller coupled to the processor operable to communicate with the processor and to interface with an external device. In block 710 the controller receives program instructions and data specifying new operating parameters from the external device.

In block 715 sensors of the battery measure certain conditions of the sub-cells, including voltages, currents and temperatures. The battery includes logic circuitry coupled to the sensors. In block 720D selected control signals are automatically asserted and de-asserted by the logic circuitry responsive to the measured conditions for the sub-cells.

In block 720 the logic circuitry makes adjustments to the battery. This includes numerous features previously described. Some of these are set out explicitly in FIG. 7 as blocks 720A through 720F, described further herein below.

In block 725 the controller sends at least part of the historical record to the external device. In block 730 the following are stored in the memory. i) instructions, ii) predefined parameters specifying operating objectives, and iii) measurements from the sensor signals.

Referring now to blocks 720A through 720F perviously mentioned, in block 720A the logic circuitry determines whether a charge cycle for a sub-cell is complete responsive to the sensor signals for the sub-cell indicating the sub-cell's voltage, current and temperature measurements are in a predetermined range within a certain time interval.

In block 720B one or more of the sub-cells is selected by the control block logic circuitry to supply the load. In some instances this is responsive to detecting that a sub-cell has repeatedly recharged to less than a certain voltage level.

In block 720C at least one of the sub-cells selected to supply the load is selected to stop supplying the load upon occurrence of a predetermined event. The events which trigger this include one or more of the following: i) the selected sub-cell's voltage drops below a specified threshold value, and ii) a specified maximum allowable on-line time period expires for the selected sub-cell.

In block 720E one or more conductive paths are selectively switched on and off by one or more output switching devices coupled to the sub-cells. This conductively couples a selected set of one or more of the sub-cells to a load and de-couples others. The output switching device or devices switch on and off the selected path or paths responsive to which control signals are asserted and de-asserted. That is, responsive to detecting an event described in connection with block 720B for a sub-cell, the sub-cell is switched out of service and another one of the sub-cells is switched to supply the load such that current to the load is maintained without interruption.

In block 720F one or more other conductive paths are selectively switched on and off by respective input switching devices coupled to the sub-cells. This conductively couples and a selected set of one or more of the sub-cells to a recharging source and de-couples others. The input switching device or devices switch on and off the selected path or paths to the recharge source responsive to another set of the control signals asserted and de-asserted by the logic circuitry. That is, a sub-cell switched out of service is switched to one of the following modes: a charge mode in which the sub-cell is conductively coupled to the recharging source so that the sub-cell may be recharged, or a maintenance mode in which the sub-cell is isolated from the source and the supply so that the sub-cell may be replaced.

The description of the present embodiment has been presented for purposes of illustration, but is not intended to be exhaustive or to limit the invention to the form disclosed. Many modifications and variations will be apparent to those of ordinary skill in the art. To reiterate, the embodiments were chosen and described in order to best explain the principles of the invention, the practical application, and to enable others of ordinary skill in the art to understand the invention. Various other embodiments having various modifications may be suited to a particular use contemplated, but maybe within the scope of the present invention. Those of ordinary skill in the art will appreciate that the hardware and methods illustrated herein may vary depending on the implementation. For example, it should be understood that while the control block logic circuitry has been described as a processor-based implementation, it would be within the spirit and scope of the invention to encompass an embodiment using a discrete logic based implementation. Also, the control block of the described embodiment maybe a cellular telephone or a personal digital assistant capable of communicating with other computers and/or telephones. Other devices, such multiple processors and memory devices and the like, may be used in addition to or in place of the hardware depicted. The depicted example is not meant to imply architectural limitations with respect to the present invention.

In this embodiment, point-to-point connections for each of the signals are illustrated. However, other embodiments use a bus, e.g., a SM bus to transfer the signals between the functional cells 510, 520 and 530 and the processor 510.

Additionally, it is important to note that while the present invention has been described in the context of having a processor and memory, those of ordinary skill in the art will appreciate that the processes of the present invention are capable of being distributed as computer readable medium of instructions in a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

To reiterate, many additional aspects, modifications and variations are also contemplated and are intended to be encompassed within the scope of the following claims. Moreover, it should be understood that in the following claims actions are not necessarily performed in the particular sequence in which they are set out.

What is claimed is:

1. A battery comprising:
a) a first rechargeable battery cell, the cell having a number of replaceable sub-cells;
b) sensors for measuring certain conditions of the sub-cells, including voltages, currents and temperatures;
c) an output switching device coupled to the sub-cells, wherein the output switching device is operable, responsive to a first control signal, to selectively switch on a conductive path to a load from selected ones of the sub-cells;
d) an input switching device coupled to the sub-cells, wherein the input switching device is operable, responsive to a second control signal, to selectively switch on a conductive path to a source from selected ones of the sub-cells; and
e) logic circuitry coupled to the sensors and the input and output switching devices operable to automatically assert the control signals responsive to the measured conditions for switching a selected at least one of the sub-cells to supply the load and at least one of the sub-cells to recharge from the source.

2. The battery of claim 1, wherein the logic circuitry determines whether a charge cycle for a sub-cell is complete responsive to the sensor signals for the sub-cell indicating the sub-cell's voltage, current and temperature measurements are in a predetermined rang within a certain time interval.

3. The battery of claim 2, wherein the control block logic circuitry selects one of the sub-cells to supply the load responsive to detecting that the sub-cell has repeatedly recharged to less than a certain voltage level.

4. The battery of claim 1, wherein such a sub-cell selected to supply the load stops supplying the load upon occurrence of a predetermined event, including one or more of the following events: the selected sub-cell's voltage drops below a specified threshold value, and a specified maximum allowable on-line time period expires for the selected sub-cell, and wherein responsive to detection of such an event for a sub-cell, the sub-cell is switched out of service and another one of the sub-cells is switched to supply the load such that current to the load is maintained without interruption.

5. The battery of claim 4, wherein the sub-cell switched out of service is switched to one of the following modes: a charge mode in which the sub-cell is conductively coupled to the recharging source so that the sub-cell may be recharged, or a maintenance mode in which the sub-cell is isolated from the source and the supply so that the sub-cell may be replaced.

6. The battery of claim 1, wherein the logic circuitry includes a processor operable to execute program instructions in response to the sensor signals and a memory coupled to the processor, wherein the memory stores i) instructions, ii) predefined parameters specifying operating objectives, and iii) measurements from the sensor signals.

7. The battery of claim 6, wherein the stored measurements provide an historical record of actual operating conditions, the stored measurements including measured values for cell voltage versus time for a number of charge and discharge cycles, cell temperature versus time for a predefined time interval, and voltages and corresponding timestamp values for a discharge low point and recharge high point.

8. The battery of claim 7, wherein the logic circuitry includes a communications controller coupled to the processor operable to communicate with the processor and to interface with an external device, wherein the controller receives program instructions and data specifying new operating parameters from the external device and sends at least part of the historical record to the external device.

9. A method for managing a battery, wherein the battery has a first rechargeable battery cell, the cell having a number of replaceable sub-cells, the method comprising the steps of:
measuring, by sensors of the battery, certain conditions of the sub-cells, including voltages, currents and temperatures;
selectively switching on a conductive path to a load from a selected at least one of the sub-cells by an output switching device coupled to the sub-cells, wherein the output switching device is responsive to a first control signal;
selectively switching on a conductive path to a recharging source from a selected at least one of the sub-cells by an input switching device coupled to the sub-cells, wherein the input switching device is responsive to a second control signal, wherein the battery includes logic circuitry coupled to the sensors, the first and second control signals being automatically asserted by the logic circuitry responsive to the measured conditions for the sub-cells.

10. The method of claim 9, comprising the step of determining, by the logic circuitry, whether a charge cycle for a sub-cell is complete responsive to the sensor signals for the sub-cell indicating the sub-cell's voltage, current and temperature measurements are in a predetermined range within a certain time interval.

11. The method of claim 10, wherein one of the sub-cells is selected by the control block logic circuitry to supply the load responsive to detecting that the sub-cell has repeatedly recharged to less than a certain voltage level.

12. The method of claim 9, wherein such a sub-cell selected to supply the load stops supplying the load upon occurrence of a predetermined event, including one or more of the following events: the selected sub-cell's voltage drops below a specified threshold value, and a specified maximum allowable on-line time period expires for the selected sub-cell, and wherein responsive to detection of such an event for a sub-cell, the sub-cell is switched out of service and another one of the sub-cells is switched to supply the load such that current to the load is maintained without interruption.

13. The method of claim 12, wherein the sub-cell switched out of service is switched to one of the following modes: a charge mode in which the sub-cell is conductively coupled to the recharging source so that the sub-cell may be recharged, or a maintenance mode in which the sub-cell is isolated from the source and the supply so that the sub-cell may be replaced.

14. The method of claim 9, wherein the logic circuitry includes a processor operable to execute program instructions in response to the sensor signals and a memory coupled to the processor, and wherein the method comprises the step of storing in the memory: i) instructions, ii) predefined parameters specifying operating objectives, and iii) measurements from the sensor signals.

15. The method of claim 14, wherein the stored measurements provide an historical record of actual operating conditions, the stored measurements including measured values for cell voltage versus time for a number of charge and discharge cycles, cell temperature versus time for a predefined time interval, and voltages and corresponding timestamp values for a discharge low point and recharge high point.

16. The method of claim 15, wherein the logic circuitry includes a communications controller coupled to the processor operable to communicate with the processor and to interface with an external device, and wherein the method comprises the steps of:
receiving, by the controller, program instructions and data specifying new operating parameters from the external device; and
sending, by the controller, at least part of the historical record to the external device.

17. A computer program product for managing a battery, wherein the battery has a first rechargeable battery cell, the cell having a number of replaceable sub-cells, the computer program product comprising:
instructions for receiving measurements by logic circuitry from sensors of certain conditions of the sub-cells, including voltages, currents and temperatures;
instructions for asserting by the logic circuitry a first control signal for selectively switching on a conductive path to a load from a selected at least one of the sub-cells by an output switching device coupled to the sub-cells;
instructions for asserting by the logic circuitry a second control signal for selectively switching on a conductive path to a recharging source from a selected at least one of the sub-cells by an input switching device coupled to the sub-cells, wherein the control signals are automatically generated by the logic circuitry responsive to the measured conditions for the sub-cells.

18. The computer program product of claim 17 comprising instructions for determining, by the logic circuitry, whether a charge cycle for a sub-cell is complete responsive to the sensor signals for the sub-cell indicating the sub-cell's voltage, current and temperature measurements are in a predetermined range within a certain time interval.

19. The computer program product of claim 18, wherein one of the sub-cells is selected by the control block logic circuitry to supply the load responsive to detecting that the sub-cell has repeatedly recharged to less than a certain voltage level.

20. The computer program product of claim 17, wherein such a sub-cell selected to supply the load stops supplying the load upon occurrence of a predetermined event, including one or more of the following events: the selected sub-cell's voltage drops below a specified threshold value, and a specified maximum allowable on-line time period expires for the selected sub-cell, and wherein responsive to detection of such an event for a sub-cell, the sub-cell is switched out of service and another one of the sub-cells is switched to supply the load such that current to the load is maintained without interruption.

21. The computer program product of claim 20, wherein the sub-cell switched out of service is switched to one of the following modes: a charge mode in which the sub-cell is conductively coupled to the recharging source so that the sub-cell may be recharged, or a maintenance mode in which the sub-cell is isolated from the source and the supply so that the sub-cell may be replaced.

22. The computer program product of claim 17, wherein the logic circuitry includes a processor operable to execute program instructions in response to the sensor signals and a memory coupled to the processor, and wherein the computer program product comprises instructions for storing in the memory: i) instructions, ii) predefined parameters specifying operating objectives, and iii) measurements from the sensor signals.

23. The computer program product of claim 22, wherein the stored measurements provide an historical record of actual operating conditions, the stored measurements including measured values for cell voltage versus time for a number of charge and discharge cycles, cell temperature versus time for a predefined time interval, and voltages and corresponding timestamp values for a discharge low point and recharge high point.

24. The method of claim 23, wherein the logic circuitry includes a communications controller coupled to the processor operable to communicate with the processor and to interface with an external device, and wherein the computer program product comprises:
instructions for receiving, by the controller, program instructions and data specifying new operating parameters from the external device; and
instructions for sending, by the controller, at least part of the historical record to the external device.
